(19) United States
(12) Patent Application Publication
(10) Pub. No.: US 2010/0304798 A1
(43) Pub. Date: Dec. 2, 2010

(54) RADIATION PROTECTION DEVICE FOR MOBILE TELEPHONES

(76) Inventor: Muhammed Refai, Hurth (DE)

Correspondence Address: GREER, BURNS & CRAIN, 300 S WACKER DR, 25TH FLOOR, CHICAGO, IL, 60606, US

(21) Appl. No.: 12/648,788

(22) Filed: Dec. 29, 2009

(30) Foreign Application Priority Data
Jun. 2, 2009 (DE) 202009001530.0 U1

(51) Int. Cl. H04M 1/00

(52) U.S. Cl. 455/575.1

(57) ABSTRACT

A radiation protection device for mobile telephones being at least one polycarbonate body affixed to the mobile telephone. The polycarbonate body may be shaped either as a lens, a disk, a polyhedron, an ellipsoid, or a prism. A part of the housing of the mobile telephone may be formed by the polycarbonate body. The polycarbonate body may be subjected to a photon treatment in the range between 240 and 960 nm prior to being affixed to the mobile telephone.

### BACKGROUND OF THE INVENTION

The present invention relates to a radiation protection device for mobile telephones. It is known that the use of mobile telephones (cell phones) is connected with radiation exposure due to magnetism or electromagnetic waves, in particular for the user during telephoning, but also in the standby state. Whether, and at what point, radiation exposure reaches the point of detectable contamination in persons differs from individual to individual. The symptoms can differ, and it may be several years before they become evident at all. The most commonly occurring signals are sleep disturbances, headaches, and vein pain.

### SUMMARY OF THE INVENTION

The present invention is based on the object of reducing radiation exposure for persons during the use of mobile telephones.

According to the present invention, this object is achieved in that at least one polycarbonate body is affixed to the mobile telephone. The affixing of this body to the mobile telephone can take place at any location on the telephone in a suitable manner, advantageously as a permanent affixing.

Very advantageously, the use of a polycarbonate body surprisingly achieves many advantages. These are:
1. Harmonization of the overall working and living environment
2. Protection of the body
3. Abatement, and in many cases removal, of pain
4. Reduction of diseases caused by radiation, such as cancer

### BRIEF DESCRIPTION OF THE DRAWINGS

Further advantages and details of the present invention are explained in more detail below, in relation to exemplary embodiments presented in schematic drawings.

FIG. 1 shows a side view of a mobile telephone having the radiation protection device according to the present invention;

FIG. 2 shows a perspective representation of a mobile telephone having the radiation protection device according to the present invention as a housing lower part.

### BRIEF DESCRIPTION OF THE DRAWINGS

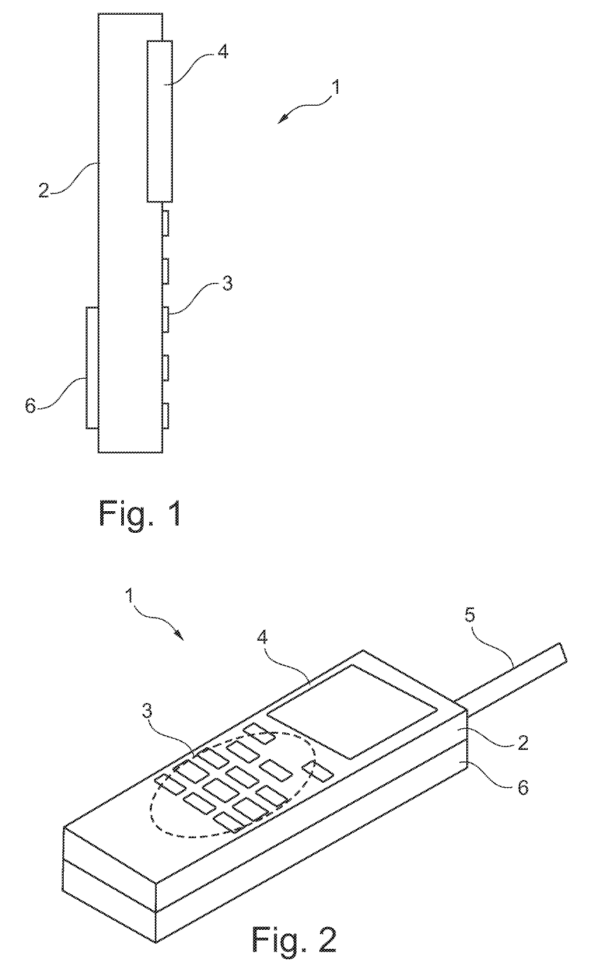

According to FIGS. 1 and 2, mobile telephones 1 each have a housing 2 having a keypad 3 and a display 4. In addition, in FIG. 2 an antenna 5 is also shown.

In FIG. 1, a polycarbonate body 6 is affixed or arrached to the rear side of the mobile telephone 1, on the housing 2, as a protective device for converting radiation. Arbitrary shapes, such as lenses, discs, polyhedra, ellipsoids, or prisms, may be used as the polycarbonate body 6. Preferably, before its use the polycarbonate body is subjected to a photon treatment or irradiation in the range between 240 and 960 nanometers (nm). Advantageously, the polycarbonate 6, here realized as a circular lens, has a diameter of approximately 30 mm and a thickness of approximately 3 mm. The polycarbonate body 6 can alternatively be fashioned as an oblong rectangle 30 mm long, 15 mm wide, and 3 mm thick, but may also be made larger or smaller than the indicated dimensions.

In the mobile telephone 1 shown in FIG. 2, the lower part of the housing 2 forms the polycarbonate body 6 as a protective device against radiation, by converting the radiation, i.e. making it harmless to the human organism.

The measures and designs according to the present invention are not limited to the described exemplary embodiments. Possible modifications of the radiation protection device according to the present invention may consist in that other materials having the same effect may be used instead of polycarbonate, and workpiece shapes other than those indicated may be used. The constructive design in the particular case is left to the person skilled in the art, to be matched to the particular application.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

### LIST OF REFERENCE CHARACTERS

1 mobile telephone
2 housing
3 keypad
4 display
5 antenna
6 polycarbonate body

1. A radiation protection device for mobile telephones, wherein at least one polycarbonate body is affixed to the mobile telephone.

2. The radiation protection device according to claim 1, wherein the polycarbonate body is fashioned as one of a lens, a disk, a polyhedron, an ellipsoid, and primatically.

3. The radiation protection device according to claim 1, wherein the polycarbonate body has a diameter of approximately 30 mm and a thickness of approximately 3 mm.

4. The radiation protection device according to claim 1, wherein the polycarbonate body is fashioned as an oblong rectangle 30 mm long, 15 mm wide, and 3 mm thick.

5. The radiation protection device according to claim 1, wherein at least a part of the housing of the mobile telephone is formed by the polycarbonate body.

6. The radiation protection device according to claim 1, wherein before its use, the polycarbonate body was subjected to a photon treatment in the range between 240 and 960 nm.

7. A radiation protection device for a mobile telephone comprising at least one polycarbonate body attached to the mobile telephone.

8. The radiation protection device according to claim 7, wherein the polycarbonate body is selected from the group consisting of a lens, a disk, a polyhedron, an ellipsoid, and a prism.

9. The radiation protection device according to claim 7, wherein the polycarbonate body is circular with a diameter of approximately 30 mm and a thickness of approximately 3 mm.

10. The radiation protection device according to claim 7, wherein the polycarbonate body is rectangular with dimensions of approximately 30 mm long, 15 mm wide, and 3 mm thick.

11. The radiation protection device according to claim 7, wherein the polycarbonate body forms at least a part of a housing of the mobile telephone.

12. The radiation protection device according to claim 7, wherein the polycarbonate body is subjected to a photon treatment in the range between 240 and 960 nm prior to being attached to the mobile telephone.
